(19) United States
(12) Patent Application Publication
(10) Pub. No.: US 2025/0042796 A1
(43) Pub. Date: Feb. 6, 2025

(54) Use of Flotation for Separation and Thickening of Ballasted Sludge

(71) Applicants: Evoqua Water Technologies LLC, Pittsburgh, PA (US); EVOQUA WATER TECHNOLOGIES LLC, Pittsburgh, PA (US)

(72) Inventor: Robert J. Wenta, Junction City, WI (US)

(73) Assignees: Evoqua Water Technologies LLC, Pittsburgh, PA (US); EVOQUA WATER TECHNOLOGIES LLC, Pittsburgh, PA (US)

(21) Appl. No.: 18/714,699

(22) PCT Filed: Jan. 27, 2023
(86) PCT No.: PCT/US2023/011686

§ 371 Date: May 30, 2024

Related U.S. Application Data
(60) Provisional application No. 63/303,711, filed on Jan. 27, 2022.

(51) Int. Cl. C02F 9/00; C02F 3/12; C02F 11/121; C02F 11/143

(52) U.S. Cl. CPC C02F 9/00; C02F 3/1221; C02F 11/121; C02F 11/143; C02F 2301/046; C02F 2303/18

(57) ABSTRACT

A method of treating wastewater comprises performing biological treatment of the wastewater to generate a sludge, adding a ballasting agent to the sludge to form a ballasted sludge, and performing solid-liquid separation of a first portion of the ballasted sludge using a dissolved air flotation process to form a solids-rich concentrated sludge and a solids-lean effluent.

### BACKGROUND

### 1. Field of Invention

Aspects and embodiments disclosed herein are generally directed to systems and method for biological treatment of wastewater.

### 2. Discussion of Related Art

Methods of treating wastewater, for example, municipal wastewater, may include biological treatment in which the wastewater is maintained under aerobic and/or anaerobic conditions conducive for bacteria to break down undesirable components in the wastewater. The biological treatment of the wastewater may generate sludge that is then separated from the treated wastewater so that the treated wastewater may be suitable for discharge into the environment.

### SUMMARY

In accordance with one aspect, there is provided a method of treating wastewater. The method comprises performing biological treatment of the wastewater to generate a sludge, adding a ballasting agent to the sludge to form a ballasted sludge, and performing solid-liquid separation of a first portion of the ballasted sludge using a dissolved air flotation process to form a solids-rich concentrated sludge and a solids-lean effluent.

In some embodiments, adding the ballasting agent to the sludge includes adding a particulate material with a higher specific gravity than the sludge.

In some embodiments, adding the ballasting agent to the sludge includes adding magnetite.

In some embodiments, the method further comprises separating the magnetite from the solids-rich concentrated sludge.

In some embodiments, the method further comprises recycling a portion of the solids-rich concentrated sludge from which the magnetite has been separated as return activated sludge to a unit operation that performs the biological treatment.

In some embodiments, the method further comprises recycling a portion of the solids-rich concentrated sludge as return activated sludge to a unit operation that performs the biological treatment.

In some embodiments, the method further comprises performing solid-liquid separation of a second portion of the ballasted sludge using a clarification process in parallel with the dissolved air flotation process to form a second solids-rich concentrated sludge and a second solids-lean effluent.

In some embodiments, the method further comprises separating the magnetite from the second solids-rich concentrated sludge.

In some embodiments, the method further comprises recycling a portion of the second solids-rich concentrated sludge from which the magnetite has been separated as return activated sludge to a unit operation that performs the biological treatment.

In some embodiments, the method further comprises recycling a portion of the second solids-rich concentrated sludge as return activated sludge to a unit operation that performs the biological treatment.

In some embodiments, the method further comprises selecting relative amounts of the first and second ballasted sludges based on a combined total amount of the first and second ballasted sludges.

In accordance with another aspect, there is provided a wastewater treatment system. The wastewater treatment system comprises a biological treatment unit including an inlet and an outlet and configured to perform biological treatment of the wastewater to produce a sludge from the wastewater, a ballast addition sub-system configured to add a ballasting agent to the sludge to produce a ballasted sludge, and a dissolved air flotation unit having an inlet configured to couple to the outlet of the biological treatment unit, the dissolved air flotation unit configured to receive a first portion of the ballasted sludge from the biological treatment unit and to separate the first portion of the ballasted sludge to form a solids-rich concentrated sludge and a solids-lean effluent.

In some embodiments, the ballast addition sub-system includes a source of the ballast, the ballast comprising a particulate material with a higher specific gravity than the sludge.

In some embodiments, the ballast comprises magnetite.

In some embodiments, the system further comprises a magnetite separation unit configured to separate the magnetite from the solids-rich concentrated sludge.

In some embodiments, the system further comprises a recycle line configured to couple to an outlet of the magnetite separation unit and to recycle a portion of the solids-rich concentrated sludge from which the magnetite has been separated to the biological treatment unit as return activated sludge.

In some embodiments, the system further comprises a recycle line configured to couple to an outlet of the dissolved air flotation unit and configured to recycle a portion of the solids-rich concentrated sludge to the biological treatment unit as return activated sludge.

In some embodiments, the system further comprises a clarifier having an inlet configured to couple to the outlet of the biological treatment unit in parallel with the dissolved air flotation unit and configured to perform solid-liquid separation of a second portion of the ballasted sludge to form a second solids-rich concentrated sludge and a second solids-lean effluent.

In some embodiments, the system further comprises a magnetite separation unit having an inlet configured to couple to an outlet of the clarifier, the magnetite separation unit configured to separate the magnetite from the second solids-rich concentrated sludge.

In some embodiments, the system further comprises a recycle line configured to couple to an outlet of the magnetite separation unit and configured to recycle a portion of the second solids-rich concentrated sludge from which the magnetite has been separated to the biological treatment unit as return activated sludge.

In some embodiments, the system further comprises a recycle line configured to couple to an outlet of the clarifier and to recycle a portion of the second solids-rich concentrated sludge to the biological treatment unit as return activated sludge.

In some embodiments, the system further comprises a valve configured to direct the first and second ballasted sludges from the outlet of the ballast addition unit to the dissolved air flotation unit and clarifier, respectively.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an example wastewater treatment system:

FIG. 2 is a block diagram of a portion of a wastewater treatment system including ballast addition and recovery operations:

FIG. 3A illustrates a shear mill that may be utilized in examples of ballast recovery systems as disclosed herein:

FIG. 3B illustrates the rotor and stator of the shear mill of FIG. 3A:

FIG. 4A illustrates an example of a magnetic separator that may be utilized in examples of ballast recovery systems as disclosed herein:

FIG. 4B illustrates another example of a magnetic separator that may be utilized in examples of ballast recovery systems as disclosed herein:

FIG. 5 is a block diagram of an example wastewater treatment system:

FIG. 6A is a block diagram of another example wastewater treatment system; and

FIG. 6B is a block diagram of the wastewater treatment system of FIG. 6A with one unit operation disabled and a diversion line included.

### DETAILED DESCRIPTION

Aspects and embodiments disclosed herein are not limited to the details of construction and the arrangement of components set forth in the following description or illustrated in the drawings. Aspects and embodiments disclosed herein are capable of being practiced or of being carried out in various ways. Also, the phraseology and terminology used herein is for the purpose of description and should not be regarded as limiting. The use of “including,” “comprising,” “having.” “containing,” “involving,” and variations thereof herein is meant to encompass the items listed thereafter and equivalents thereof as well as additional items.

Aspects and embodiments disclosed herein include wastewater treatment systems and methods of operation of same. The type and configuration of the biological treatment unit operations of the wastewater treatment systems described below are non-limiting examples.

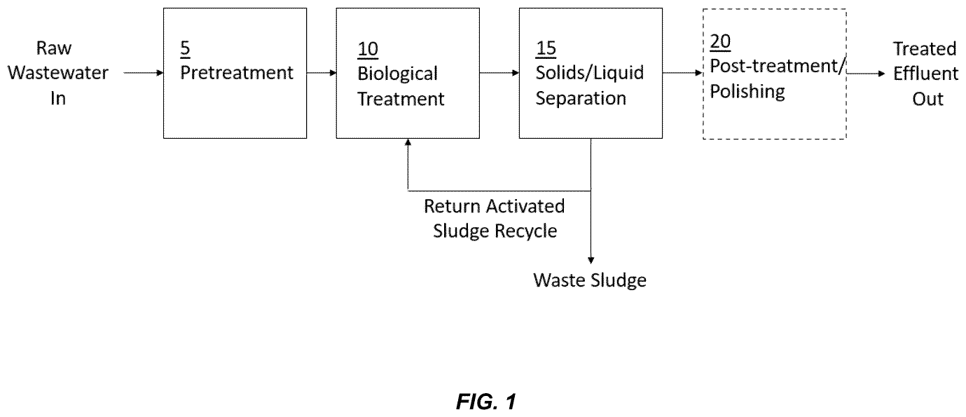

Many wastewater treatment systems include three main stages-pretreatment, biological treatment, and solids/liquid separation. The three main stages are illustrated in the block diagram of FIG. 1.

The pretreatment stage 5 may include operations such as screening to remove branches, rags, or other detritus from the influent wastewater. In systems designed to treat wastewater including fats, oils, or grease, the pretreatment stage 5 may also include a flotation separation tank in which the fats, oils, or grease is allowed to float to the surface of the influent wastewater and is skimmed off for disposal. The pretreatment stage may also include a rough clarification step in which grit, clay, soil, or other heavier particulate matter is allowed to settle out of the influent wastewater and be removed for disposal.

In the biological treatment stage 10 bacteria act on undesired dissolved or suspended solids, for example, undesired organic components to convert these components into less objectional forms and/or to reduce total mass of these components. The type of biological treatment utilized may be selected based on the types of components desired to be removed from the wastewater. For example, bacteria operating under aerobic conditions may be used to oxidize biological components or hydrocarbons at least partially to, for example, carbon dioxide. If the wastewater includes ammonia or nitrates, a combination of aerobic and anaerobic biologic treatment operations may convert the ammonia or nitrates at least partially into nitrogen. In different systems, the biological treatment stage 10 may include different biological reactors maintained under different oxidation conditions conducive to the growth and biological activity of different species of bacteria, for example, aerobic, anaerobic, anoxic, or aerated anoxic conditions to provide bacteria that are capable of consuming or breaking down particular contaminants of concern in the wastewater. In other systems the biological treatment stage 10 may include one or more sequencing batch reactors that operate in batch mode and that may subject the wastewater being treated to one or more different oxidation environments at different time within a batch cycle. Liquid that leaves the biological treatment stage 10, often referred to as mixed liquor or sludge, the two terms being used synonymously herein, may include living and dead bacteria, components of dead bacteria, byproducts of the biological treatment operation, and/or material in the wastewater that was not broken down by the bacterial treatment. Such remaining compounds may be collectively referred to as mixed liquor suspended solids (MLSS). The presence of the MLSS in the mixed liquor/sludge output from the biological treatment stage 10 may render this mixed liquor/sludge unsuitable for discharge to the environment.

The solids/liquid separation stage 15 may be used to separate the mixed liquor/sludge from the biological treatment stage 10 into a solids-lean effluent and a solids-rich concentrated sludge. The solids/liquid separation stage may utilize one or more of clarifiers, dissolved air filtration units, centrifuges, hydrocyclones, or other forms of separation technologies to achieve the solids/liquid separation. The solids-rich concentrated sludge may contain sufficient amount of useful living bacteria that at least a portion of the solids-rich concentrated sludge is recycled to the biological treatment stage 10 as return activated sludge to provide additional bacteria for the biological treatment. Excess solids-rich concentrated sludge or solids-rich concentrated sludge lacking useful bacteria may be discarded as waste 30) sludge which may be subjected to drying and disposal by, for example, landfill or incineration. The solids-lean effluent produced from the mixed liquor/sludge in the solids/liquid separation stage may be sufficiently low in undesirable components that it satisfies regulatory requirements for discharge to the environment. In some processes the solids-lean effluent produced from the mixed liquor in the solids/liquid separation stage may be subjected to post-treatment or polishing 20 for further purification or deactivation of residual pathogens prior to discharge to the environment. The post-treatment or polishing stage 20 may include, for example, UV-light treatment, heat treatment, media filtration, ion exchange treatment, electrical based separation technologies (e.g., electrodialysis or electrodeionization), and/or fine filtration such as nanofiltration, ultrafiltration, or reverse osmosis, depending on the residual contaminants in the solids-lean effluent and requirements for environmental discharge in the jurisdiction in which the wastewater treatment system is located.

In wastewater treatment systems utilizing clarifiers in the solids/liquid separation stage 15, the clarifiers rely on gravity to cause residual solids in the mixed liquor from the biological treatment stage 10 to separate out from the solids-lean effluent and settle at the bottom of the clarifier vessel(s). The settled solids form the solids-rich concentrated sludge which is removed from the bottom of the clarifier vessels, for example, with scraper flights or hydraulic suction headers, while the solids-lean effluent is decanted from near the top of the clarifier vessel. The higher the specific gravity of the residual solids, the faster they will settle out in the clarifier vessel and provide for a sufficiently clean solids-lean effluent to be decanted.

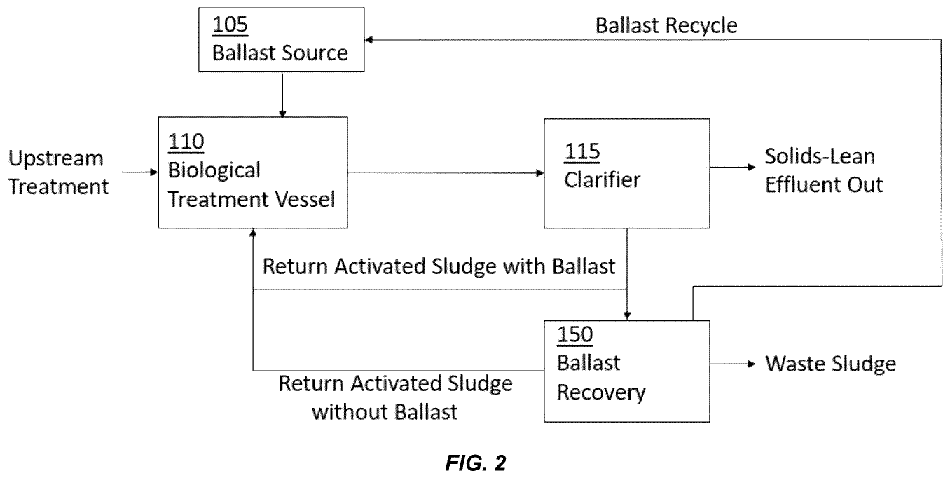

Accordingly, in some treatment systems, especially those that treat wastewater that results in low specific gravity residual solids in sludge from the biological treatment stage, the specific gravity of the sludge may be increased by adding a ballast material having a higher specific gravity than the sludge into the sludge. Some examples of material that may be utilized as ballast include sand, carbon, or magnetite. As illustrated in FIG. 2, a source of ballast material 105 may be used to add ballast into one of the biological treatment vessels of the biological treatment stage 10, for example, the most downstream biological treatment vessel 110. The ballast material becomes enmeshed in the sludge in the biological treatment vessel and increases the rate at which the residual solids separate from the sludge to produce the solids-lean effluent and solids-rich concentrated sludge in the clarifier 115. At least a portion of the solids-rich concentrated sludge separated from the mixed liquor in the clarifier 115 may be returned to the biological treatment vessel 110 and/or other biological treatment vessels upstream of biological treatment vessel 110 as return activated sludge to supplement the bacterial populations in the biological treatment vessel(s). In some systems and methods, the return activated sludge still includes ballast material. The return activated sludge may thus both supplement the bacterial population(s) in the biological treatment vessel(s) and add ballast to the sludge being produced in the biological treatment process to facilitate settling of suspended solids in the clarifier.

In other systems and methods, it may be desirable to recover ballast from the return activated sludge prior to recycling the return activated sludge to a biological treatment vessel and/or to recover ballast from solids-rich concentrated sludge that is to be disposed of as waste solids. Such systems and methods may thus employ a ballast recovery system 150 as further illustrated in FIG. 2. Solids-rich concentrated sludge from which ballast has been at least partially or fully removed in the ballast recovery system 150 may be recycled to a biological treatment vessel as substantially or wholly ballast-free return activated sludge. Ballast that was separated from the solids-rich concentrated sludge in the ballast recovery system 150 may be reused and recycled to the source of ballast 105.

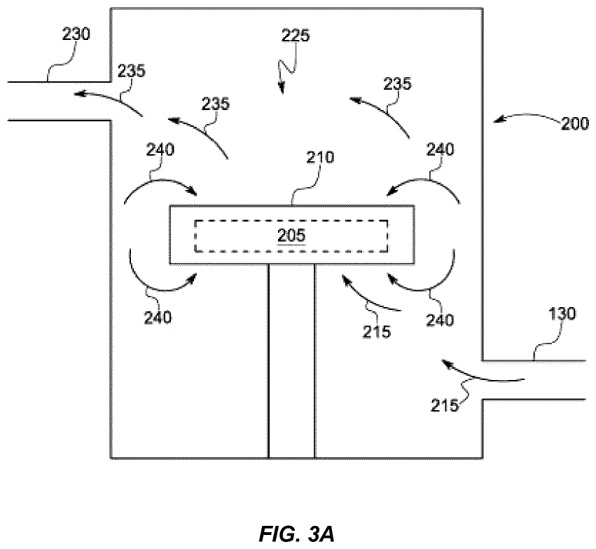

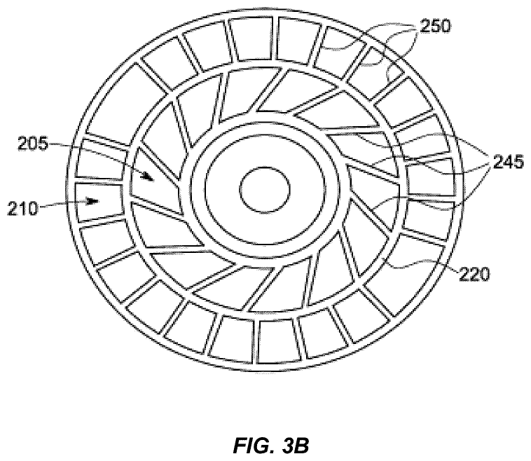

Examples of systems for recovering ballast from ballasted solids-rich concentrated sludge which may be included or utilized as the ballast recovery system 150 are described in U.S. Pat. No. 10,829,402 (the '402 Patent), incorporated herein by reference. As disclosed in the '402 Patent, according to one example, the ballast recovery system 150 includes a shear mill as illustrated generally at 200 in FIG. 3A. The shear mill 200 shears the ballasted solids-rich concentrated sludge to separate the ballast from the solids-rich concentrated sludge. The shear mill 200 may include a rotor 205 and stator 210. In operation, the ballasted solids-rich concentrated sludge 130 enters the shear mill 200 and flows in the direction of arrows 215 and enters the rotor 205 and then the stator 210. The shear mill 200 may be designed such that there is a close tolerance between the rotor 205 and the stator 210, as shown at 220 in FIG. 3B. The rotor 205 is in some embodiments driven at high rotational speeds, for example, greater than about 1,000 rpm to form a mixture of ballast and substantially ballast free obliterated flocs of solids-rich concentrated sludge in area 225 (FIG. 3A) of the shear mill 200. The mixture of ballast and obliterated flocs exits the shear mill 200 through conduit 230, as shown by arrows 235. The conduit 230, in some embodiments, leads to a separate subsystem of the ballast recovery system 115 that divides the ballast and substantially ballast-free obliterated flocs of solids-rich concentrated sludge into separate streams which are output as recovered ballast 120 and recovered solids-rich concentrated 30) sludge 125, respectively.

In some embodiments the rotor 205 and/or stator 210 include slots which function as a centrifugal pump to draw the solids-rich concentrated sludge from above and below rotor 205 and stator 210, as shown by paths 240 in FIG. 3A. The rotor and stator then hurl the materials off the slot tips at a very high speed to break the ballasted solids-rich concentrated sludge into the mixture of ballast and obliterated flocs of solids-rich concentrated sludge. For example, the rotor 205 may include slots 245, and the stator 210 may include slots 250. The slots 245 in the rotor 205 and/or the slots 250 in the stator 210 may be designed to increase shear energy to efficiently separate the ballast from the ballast-containing solids-rich concentrated sludge. The shear developed by the rotor 205 and stator 210 may depend on the width of slots 245 and 250, the tolerance between the rotor 205 and stator 210, and the rotor tip speed. The result is that the shear mill 200 provides a shearing effect that effectively and efficiently separates the ballast from the ballasted solids-rich concentrated sludge to facilitate recovery of the ballast.

According to another example, the ballast recovery system 115 may use ultrasound as a separation mechanism. For example, the ballast recovery system 115 may include one or more ultrasonic transducers. The ultrasonic transducers generate fluctuations of pressure and cavitation in the ballasted solids-rich concentrated sludge 130, which results in microturbulences that produce a shearing effect to create a mixture of ballast and obliterated flocs of solids-rich concentrated sludge to effectively separate the ballast from the recovered solids-rich concentrated sludge 125. The resulting mixture of ballast and obliterated flocs comprising the recovered solids-rich concentrated sludge 125 may exit the ultrasonic separator and pass through a separate subsystem of the ballast recovery system 115 which divides the recovered ballast and substantially ballast free obliterated flocs of solids-rich concentrated sludge into separate streams which are output as recovered ballast 120 and recovered solids-rich concentrated sludge 125, respectively.

According to another example, the ballast recovery system 115 may use centrifugal force as a separation mechanism. For instance, in some embodiments the mixture of ballast and obliterated flocs exiting the shear mill 200 of FIGS. 3A and 3B or the ultrasonic separator described above may be divided into separate streams in a centrifugal separator. The centrifugal separator generates centrifugal force that causes the denser ballast to be separated from the flocs of solids-rich concentrated sludge in the mixture and exit the ballast recovery system as recovered ballast 120. The less dense flocs of solids-rich concentrated sludge exit the ballast recovery system as recovered solids-rich concentrated sludge 125.

According to some embodiments, the ballast recovery system 115 may use centrifugal force alone without a shear mill or ultrasonic separation device. According to other embodiments, the ballast recovery system 115 may include a shear mill, an ultrasonic separator, and/or a centrifugal separator. Other types of separation devices may be included in the ballast recovery system 115. For instance, the ballast recovery system 115 may include a tubular bowl, a chamber bowl, an imperforate basket, a disk stack separator, or other forms of separation systems known by those skilled in the art.

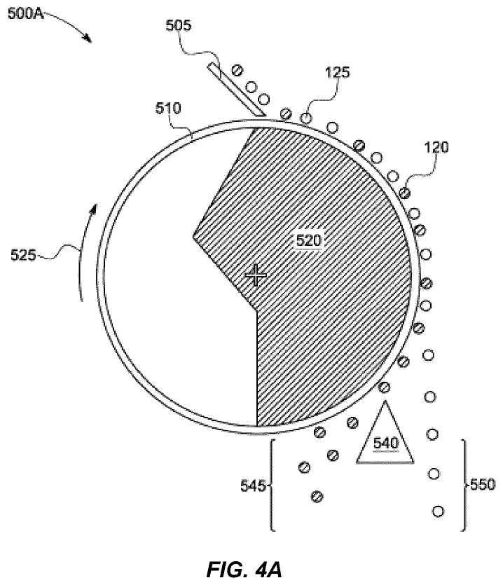

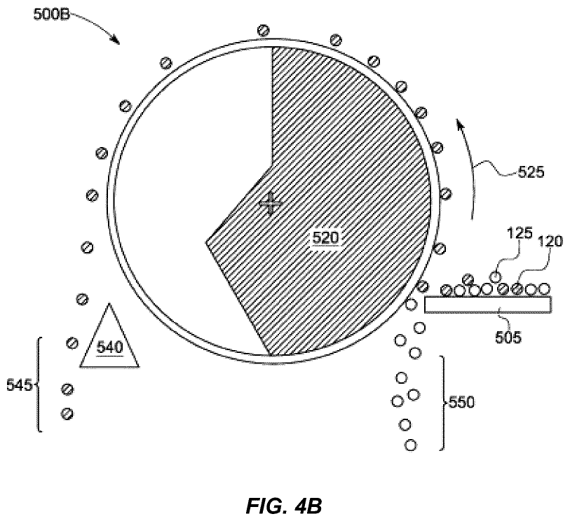

In some embodiments, ballast recovery system 115 includes a magnetic drum separator. For example, the mixture of ballast and obliterated flocs of solids-rich concentrated sludge exiting the shear mill 200 of FIG. 3A, or exiting an ultrasonic separator as described above may be divided into separate streams in a magnetic drum separator. One example of a magnetic drum separator is indicated generally at 500A in FIG. 4A. The magnetic drum separator 500A includes a drum 510 in which is disposed a magnet 520. The drum rotates in the direction of arrow 525, clockwise in this example. A mixture of ballast 120, represented by the colored circles in FIG. 4A, and obliterated flocs of solids-rich concentrated sludge 125, represented by the empty circles in FIG. 4A, are introduced to the surface of the rotating drum 510 through a conduit or feed ramp 505. The ballast, when comprised of a magnetic material, for example, magnetite, adheres more strongly to the drum 510 than the obliterated flocs of solids-rich concentrated sludge due to the presence of the magnet 520. The obliterated flocs of solids-rich concentrated sludge will fall off of the drum, in some examples aided by centripetal force generated by the rotating drum, before the ballast. A division vane 540 may separate the recovered ballast 120 and obliterated flocs of solids-rich concentrated sludge 125 into two separate output streams 545 (as recovered ballast 120), and 550) (as recovered solids-rich concentrated sludge 125), respectively.

In another embodiment of the magnetic separator, indicated generally at 500B in FIG. 4B, the mixture of ballast and obliterated flocs of solids-rich concentrated sludge is introduced by a conduit or feed ramp 505 to a position proximate and to the side of the rotating drum 510. The ballast, when comprised of a magnetic material such as magnetite, adheres to the rotating drum 510 due to the presence of the magnet 520 and may be removed from the rotating drum on the opposite side from the conduit or feed ramp 505 by, for example, a scraper or division vane 540. The obliterated flocs of solids-rich concentrated sludge do not adhere to the rotating drum 510 and instead drop from the end of the conduit or feed ramp 505. The result is the production of separate streams 545 (as recovered ballast 120) and 550 (as recovered solids-rich concentrated sludge 125).

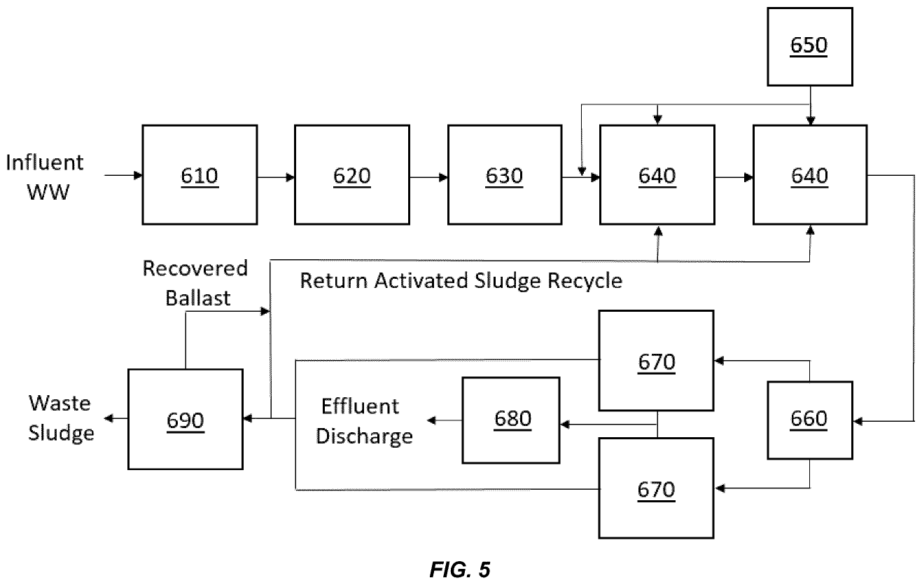

A block diagram of a wastewater treatment system that may be particularly useful for the treatment of refinery wastewater or wastewaters contaminated with oil or other hydrocarbons is illustrated in FIG. 5. In the system of FIG. 5 influent wastewater enters one or more receiving tanks 610 (only one illustrated in FIG. 5 for clarity-if more than one is utilized they would be arranged in parallel). The receiving tank(s) 610 may be fitted with a course filtration mechanism, for example, a screen with ¼ inch openings. The receiving tank(s) 610 may function as rough clarifiers and oil flotation vessels in which oils float to the tops of the wastewater in the receiving tank(s) 610 for removal by skimmers while heavier solids sink to the bottoms of the receiving tanks(s) 610 from which the solids are periodically removed and disposed of.

The wastewater flows from the receiving tank(s) 610 into one or more equalization tanks 620 (only one illustrated in FIG. 5 for clarity-if more than one is utilized they could be arranged in parallel). The equalization tanks act as holding tanks that regulate the flow of wastewater into downstream unit operations so the wastewater flow does not increase suddenly and overwhelm the downstream operation during times of high influent wastewater flow, for example, during storms.

Downstream of the equalization tanks 620 are dissolved nitrogen flotation vessels 630 (only one illustrated in FIG. 5 for clarity-if more than one is utilized they would be arranged in parallel). The dissolved nitrogen flotation vessels 630 inject small bubbles of nitrogen, or water including dissolved nitrogen which evolves from solution and forms bubbles in the vessels, into the wastewater to cause further oils or hydrocarbons to float to the top of the wastewater in the dissolved nitrogen flotation vessels 630 from which it is removed. Nitrogen is used instead of air or another oxygen-containing gas to minimize the risk of ignition of the oils or hydrocarbons in case of an ignition source.

Wastewater exits the dissolved nitrogen flotation vessels 630 and enters a biological treatment stage including, in the example of FIG. 5, two biological treatment vessels 640) arranged in series in which the wastewater undergoing biological treatment is maintained under aerobic conditions to oxidize further hydrocarbons or other organic materials in the wastewater into less undesirable forms, for example, into carbon dioxide and water. The product exiting the biological treatment vessels 640 is in the form of a dilute sludge including living and dead bacteria, waste products of the biological treatment that were not fully oxidized into gaseous form, and unreacted contaminants. Prior to exiting the second biological treatment vessel 640, a ballasting agent (magnetite) is added to the sludge from a source of ballast 650. In other embodiments, the ballasting agent may be added to the first biological treatment vessel 640 or upstream of the first biological treatment vessel (for example, between the dissolved nitrogen flotation vessels 630 and the first biological treatment vessel) instead of or in addition to the second biological treatment vessel.

After treatment in the biological treatment stage, the ballasted sludge passes through a splitter 660 and into two clarifiers 670 operating in parallel. The clarifiers 670 perform solids/liquid separation on the ballasted sludge to produce a solids-rich concentrated sludge and a solids-lean effluent. The solids-lean effluent is filtered through a sand filter 680 and discharged to the environment, for example, into a lake proximate the treatment plant.

The majority (>90) %) of the solids-rich concentrated sludge produced in the clarifiers 670 is recycled as return activated sludge to the biological treatment vessels 640. The remaining amount of the solids-rich concentrated sludge is disposed of as waste activated sludge after passing through a ballast recovery system 690 that includes a magnetic separator as described above. Ballast that is recovered from the waste activated sludge in the ballast recovery system is combined with the return activated sludge stream for recycle to the biological treatment vessels.

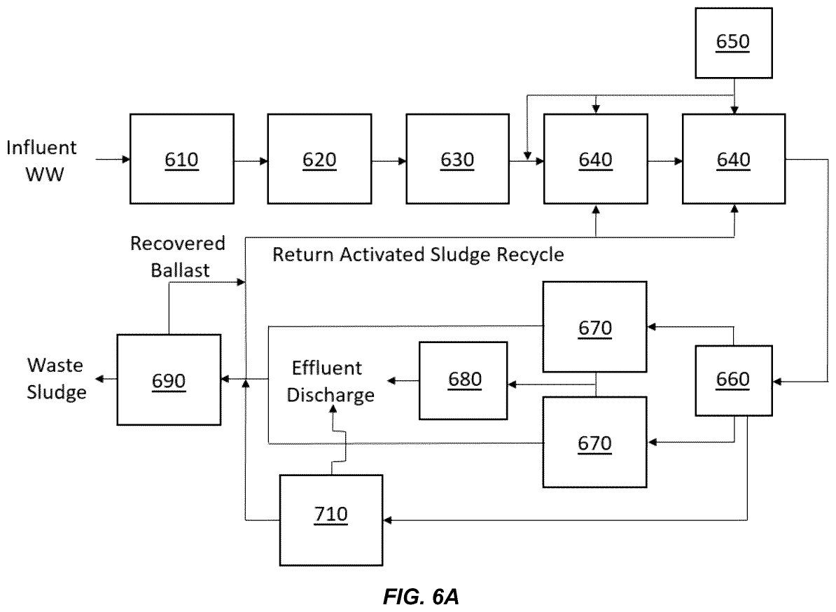

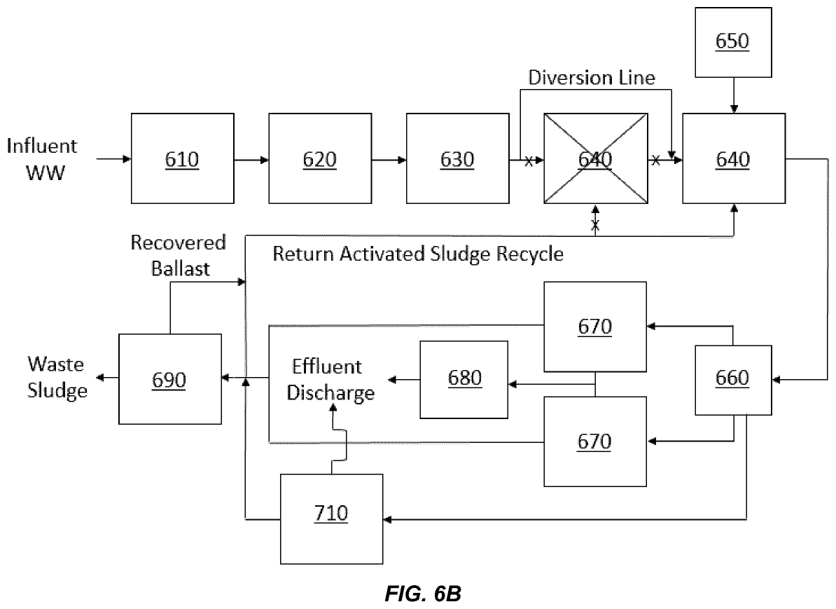

In a system such as illustrated in FIG. 5, one of the biological treatment vessels 640) may be occasionally taken out of service for maintenance or in response to a malfunction. In such instances, all biological treatment is performed in the remaining operational biological treatment vessel 640. This is illustrated in FIG. 6B in which the first of the biological treatment vessels 640) includes an “X” indicating the vessel as being out of service. A diversion line provides flow of all wastewater from the dissolved nitrogen flotation vessels 630 into the second of the biological treatment vessels 640. The remaining operational biological treatment vessel 640 may be operated with a higher bacterial population and aeration rate than when both biological treatment vessels 640 are in operation to perform the desired biological treatment. The output of the remaining operational biological treatment vessel 640) would be a thicker sludge than the sludge output from the second biological treatment vessel 640 when the two biological treatment vessels 640 were operating together in series. The resultant thicker sludge would tend to settle and compact less quickly in the clarifiers 670 than the sludge normally produced by the two biological treatment vessels 640) operating together in series. The clarifiers 670 may thus be unable to perform the solids/liquid separation of the thicker sludge and produce a sufficiently high quality solids-lean effluent in an acceptable amount of time. Solids/liquid separation capacity of the system may also be unacceptably low if one of the clarifiers were brought offline for maintenance or due to a malfunction.

To address the potential loss of solids/liquid separation capacity without adding significant footprint to the wastewater treatment system, additional solids/liquid separation capacity, in the form of dissolved air flotation units may be added to operate in parallel with the clarifiers 670 or to completely replace the clarifiers 670. Such a modified system is illustrated in FIG. 6A with the dissolved air flotation units shown as single block 710, although it is to be appreciated that multiple dissolved air flotation units may be provided to operate in parallel. Like the clarifiers 670, the dissolved air flotation units separate the sludge from the biological treatment operation into a solids-rich concentrated sludge and a solids-lean effluent. The vertical direction of solids/liquid separation in the dissolved air flotation units 710 is opposite to that in the clarifiers 670. Rather than allowing the solids in the sludge to settle to form the solids-rich concentrated sludge, as in the clarifiers 670, the dissolved air flotation units perform the solids/liquid separation by floating the sludge solids to the top of the liquid in the dissolved air flotation units where it compacts to form the solids-rich concentrated sludge. The solids-lean effluent is withdrawn from lower portions of the dissolved air flotation units 710. The solids-rich concentrated sludge produced in the dissolved air flotation units may be split into return active sludge and waste sludge streams like the solids-rich concentrated sludge produced in the clarifiers 670, or may be directed only into the return active sludge stream or only into the waste sludge stream. In some embodiments, a portion of the solids-lean effluent produced in the clarifiers 670 or dissolved air flotation units 710 may be exposed to pressurized air to dissolve the air into the effluent which is then returned to the dissolved air flotation units 710 to produce the air bubbles used in the dissolved air flotation units 710 to facilitate the solids/liquid separation.

The amount of sludge from the biological treatment operation directed to the clarifiers 670 for solids/liquid separation as compared to the amount of the sludge directed to the dissolved air flotation units 710 for solids/liquid separation may be selected based on the total amount of sludge produced in the biological treatment operation. Clarifiers are typically more energy efficient than dissolved air flotation units as there is no need for air pumps or systems for dissolving air into liquid in a clarifier. Accordingly, in some embodiments, the clarifiers 670) could be used at the exclusion of the dissolved air flotation units 710 until the capacity of the clarifiers 670 was exceeded, at which point, sludge could be directed to the dissolved air flotation units for solids/liquid separation and the dissolved air flotation units and any operational clarifiers could operate in parallel. In other embodiments, due to the faster solids/liquid separation and higher concentration of solids in the solids-rich concentrated sludge produced in the dissolved air flotation units 710 as compared to that produced in the clarifiers 670, the dissolved air flotation units 710 could be used at the exclusion of the clarifiers 670 until the capacity of the dissolved air flotation units 710 was exceeded, at which point, sludge could be directed to the clarifiers 670 for solids/liquid separation and the dissolved air flotation units 710 and clarifiers 670 could operate in parallel. Thicker sludge, such as would be produced in the dissolved air flotation units 710 as compared to the clarifiers 670, has a hydraulic advantage in pumping and piping size, as well as a lower hydraulic loading on the downstream sludge dewatering step, which would be expected to result in superior dewatering performance. One or more valves in the splitter 660 may be utilized to selectively direct sludge into the different clarifiers 670 and/or dissolved air flotation units 710.

Utilizing a dissolved air flotation unit to perform solids/liquid separation on ballasted sludge is counterintuitive and the inventors at first did not believe that a dissolved air flotation unit could be operated to successfully perform solids/liquid separation on ballasted sludge. As known in the art and as described briefly above, a dissolved air floatation unit relies on the injection of a gas, for example, air, as small bubbles or dissolved in water, into a fluid suspension where the gas bubbles attach to suspended solids and cause them to rise to the top of the fluid suspension from where they may be removed. Ballasted sludge, however, contains ballast material that is intended to cause suspended solids in which it is enmeshed to settle to the bottom of a solids/liquid separation apparatus such as a clarifier rather than to float. Testing, however, illustrated that sludge produced from the biological treatment operation in a system such as illustrated in FIG. 5 including magnetite ballast could indeed be successfully separated into solids-rich concentrated sludge and solids-lean effluent in a dissolved air flotation unit. It was found that the solids concentration of the solids-rich concentrated sludge produced in a dissolved air flotation unit was higher than the concentration of the solids-rich concentrated sludge separated from the same ballasted sludge in a clarifier by a factor of roughly three times.

### Example

Results of a prophetic example illustrating the expected effectiveness of a dissolved air flotation unit on performing solids/liquid separation of ballasted sludge produced from biological treatment of wastewater as described with reference to the wastewater treatment systems above is provided below: One possible dissolved air flotation unit type that may be used is the RT-100 dissolved air flotation unit from Evoqua Water Technologies LLC. The prophetic operating parameters and suspended solids and turbidity of effluent (Eff) produced from influent sludge with varying total suspended solids (TSS) levels from a number of different prophetic examples operated with different air-to-solids ratios (A:S) in the RT-100 dissolved air flotation unit are provided in the table below:

### Prophetic DAF Test Results

| Flow | Flow | Sludge | Flux | Flux | | Eff | |
|---|---|---|---|---|---|---|---|
| (Qᵢ), | (Qᵣ), | TSS, | (HYD) | (TSS) | | TSS, | Eff |
| gpm | gpm | mg/l | gpm/ft² | lb/hr/ft² | A:S | mg/l | Turbidity |
| 60 | 90 | 6200 | 1.5 | 1.8 | 0.03 | 9.5 | 4.5 |
| 80 | 90 | 6100 | 1.7 | 2.5 | 0.02 | 10.0 | 3.2 |
| 95 | 90 | 6300 | 1.8 | 3.0 | 0.02 | 4.8 | 2.2 |
| 120 | 90 | 6000 | 2.1 | 3.6 | 0.01 | | 2.4 |
| 115 | 90 | 6200 | 2.0 | 3.5 | 0.02 | 1.0 | 2.9 |
| 110 | 90 | 5300 | 2.0 | 3.0 | 0.02 | | 9.4 |
| 110 | 90 | 6200 | 2.0 | 3.3 | 0.02 | 4.0 | |

Qᵢ = influent sludge flow rate
Qᵣ = recycled effluent flow rate

These prophetic results illustrate that a dissolved air flotation unit can produce high quality low TSS effluent from biological sludge having TSS levels of about 6000 mg/l or greater.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of treating wastewater comprising:
performing biological treatment of the wastewater to generate a sludge:
adding a ballasting agent to the sludge to form a ballasted sludge; and
performing solid-liquid separation of a first portion of the ballasted sludge using a dissolved air flotation process to form a solids-rich concentrated sludge and a solids-lean effluent.

2. The method of claim 1, wherein adding the ballasting agent to the sludge includes adding a particulate material with a higher specific gravity than the sludge.

3. The method of claim 2, wherein adding the ballasting agent to the sludge includes adding magnetite.

4. The method of claim 3, further comprising separating the magnetite from the solids-rich concentrated sludge.

5. The method of claim 4, further comprising recycling a portion of the solids-rich concentrated sludge from which the magnetite has been separated as return activated sludge to a unit operation that performs the biological treatment.

6. The method of claim 1, further comprising recycling a portion of the solids-rich concentrated sludge as return activated sludge to a unit operation that performs the biological treatment.

7. The method of claim 1, further comprising performing solid-liquid separation of a second portion of the ballasted sludge using a clarification process in parallel with the dissolved air flotation process to form a second solids-rich concentrated sludge and a second solids-lean effluent.

8. The method of claim 7, further comprising separating the magnetite from the second solids-rich concentrated sludge.

9. The method of claim 8, further comprising recycling a portion of the second solids-rich concentrated sludge from which the magnetite has been separated as return activated sludge to a unit operation that performs the biological treatment.

10. The method of claim 7, further comprising recycling a portion of the second solids-rich concentrated sludge as return activated sludge to a unit operation that performs the biological treatment.

11. The method of claim 7, further comprising selecting relative amounts of the first and second ballasted sludges based on a combined total amount of the first and second ballasted sludges.

12. A wastewater treatment system comprising:
a biological treatment unit including an inlet and an outlet and configured to perform biological treatment of the wastewater to produce a sludge from the wastewater;
a ballast addition sub-system configured to add a ballasting agent to the sludge to produce a ballasted sludge; and
a dissolved air flotation unit having an inlet configured to couple to the outlet of the biological treatment unit, the dissolved air flotation unit configured to receive a first portion of the ballasted sludge from the biological treatment unit and to separate the first portion of the ballasted sludge to form a solids-rich concentrated sludge and a solids-lean effluent.

13. The system of claim 12, wherein the ballast addition sub-system includes a source of the ballast, the ballast comprising a particulate material with a higher specific gravity than the sludge.

14. The system of claim 13, wherein the ballast comprises magnetite.

15. The system of claim 14, further comprising a magnetite separation unit configured to separate the magnetite from the solids-rich concentrated sludge.

16. The system of claim 15, further comprising a recycle line configured to couple to an outlet of the magnetite separation unit and to recycle a portion of the solids-rich concentrated sludge from which the magnetite has been separated to the biological treatment unit as return activated sludge.

17. The system of claim 13, further comprising a recycle line configured to couple to an outlet of the dissolved air flotation unit and configured to recycle a portion of the solids-rich concentrated sludge to the biological treatment unit as return activated sludge.

18. The system of claim 13, further comprising a clarifier having an inlet configured to couple to the outlet of the biological treatment unit in parallel with the dissolved air flotation unit and configured to perform solid-liquid separation of a second portion of the ballasted sludge to form a second solids-rich concentrated sludge and a second solids-lean effluent.

19. The system of claim 18, further comprising a magnetite separation unit having an inlet configured to couple to an outlet of the clarifier, the magnetite separation unit configured to separate the magnetite from the second solids-rich concentrated sludge.

20. The system of claim 19, further comprising a recycle line configured to couple to an outlet of the magnetite separation unit and configured to recycle a portion of the second solids-rich concentrated sludge from which the magnetite has been separated to the biological treatment unit as return activated sludge.

21. The system of claim 18, further comprising a recycle line configured to couple to an outlet of the clarifier and to recycle a portion of the second solids-rich concentrated sludge to the biological treatment unit as return activated sludge.

22. The system of claim 13, further comprising a valve configured to direct the first and second ballasted sludges from the outlet of the ballast addition unit to the dissolved air flotation unit and clarifier, respectively.
